(19) United States
(12) Patent Application Publication
(10) Pub. No.: US 2024/0008068 A1
(43) Pub. Date: Jan. 4, 2024

(54) 5G/6G CARRIER AGGREGATION EFFICIENCY

(71) Applicant: T-Mobile Innovations LLC, Overland Park, KS (US)

(72) Inventors: Akin Ozozlu, McLean, VA (US); Nagi A. Mansour, Arlington, VA (US); Jawad Bin Emad, Ashburn, VA (US)

(21) Appl. No.: 17/854,411

(22) Filed: Jun. 30, 2022

(51) Int. Cl. H04W 72/08; H04W 72/04

(52) U.S. Cl. CPC H04W 72/085; H04W 72/0453

(57) ABSTRACT

Systems and methods are provided herein to provide dynamic carrier aggregation. The channel condition for each channel of a plurality of channels used for communication between a cell and a user equipment (UE) is determined as well as the utilization of each of the plurality of channels. Carrier aggregation modifications are performed if the channel condition exceeds a first threshold and the utilization exceeds a second threshold. The carrier aggregation modifications can include increasing or decreasing a number of channels assigned to the UE.

### BACKGROUND

Mobile devices depend on radio frequencies to connect to a mobile network. In 5G and 6G networks carrier aggregation systems assign user equipment (UE) to specific frequency allocations and cells. Existing carrier aggregation systems do not prioritize secondary cells and have only basic buffer up switch parameters. In addition, secondary cells (Scells) are allocated on a semi-static basis, resulting in inefficient use of baseband resources. Improved carrier aggregation systems can provide extended coverage to UEs and also increase network capacity.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods and systems for improved carrier aggregation systems with increased efficiency are provided. Aspects of the disclosure provide a method for dynamic carrier aggregation. The method begins with determining a channel condition for each channel of a plurality of channels being used to communicate between a cell and a user equipment (UE). Next, a utilization of each of the plurality of channels is determined. A UE may use multiple channels in a dual carrier system using carrier aggregation. Based on the determination that the channel condition exceeds a first threshold and the utilization exceeds a second threshold, one or more carrier aggregation modifications can be performed. As one example of a carrier aggregation modification, the UE can be assigned additional channels.

In a further embodiment, a system for dynamic carrier aggregation is provided. The system includes a cell in communication with a user equipment (UE), with the UE incorporating one or more processors that are configured to perform a method. The method begins with determining a first signal quality measurement of a first downlink signal between the cell and the UE. Next, a set of channels allocated to the UE is determined. The loading metric for each of the channels allocated to the UE is also determined. The method concludes with performing one or more carrier aggregation modifications to the set of channels allocated to the UE based on the first signal quality measurement. The carrier aggregation modifications can include assigning additional channels to the UE or reducing the number of channels assigned to the UE.

An additional embodiment provides a computer-implemented method for dynamic carrier aggregation. The method begins with determining a channel condition for each channel in a plurality of channels being used to communicate between a cell and a user equipment (UE). A utilization of each of the plurality of channels is then determined. Based on at least one of the channel condition and the utilization of each of the plurality of channels one or more carrier aggregation modifications are performed.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a cellular network suitable for use in implementations of the present disclosure, in accordance with aspects herein;

FIG. 3 depicts a dual connectivity network environment suitable for use in implementations of the present disclosure, in accordance with aspects herein;

FIG. 4 depicts carrier aggregation between Primary Cells (Pcells) using different time division duplex (TDD) carriers, in which implementations of the present disclosure may be employed, in accordance with aspects herein;

FIG. 5 is a flow chart of an exemplary method for improving 5G/6G carrier aggregation, in which aspects of the present disclosure may be employed, in accordance with aspects herein;

FIG. 6 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Transmission Receive Power
RSRQ Reference Transmission Receive Quality
RSSI Received Transmission Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 25th Edition (2009).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an EnodeB). In this regard, typically only one active uplink connection can occur per frequency. The base station may include one or more sectors served by individual transmitting/receiving components associated with the base station (e.g., antenna arrays controlled by an EnodeB). These transmitting/receiving components together form a multi-sector broadcast arc for communication with mobile handsets linked to the base station.

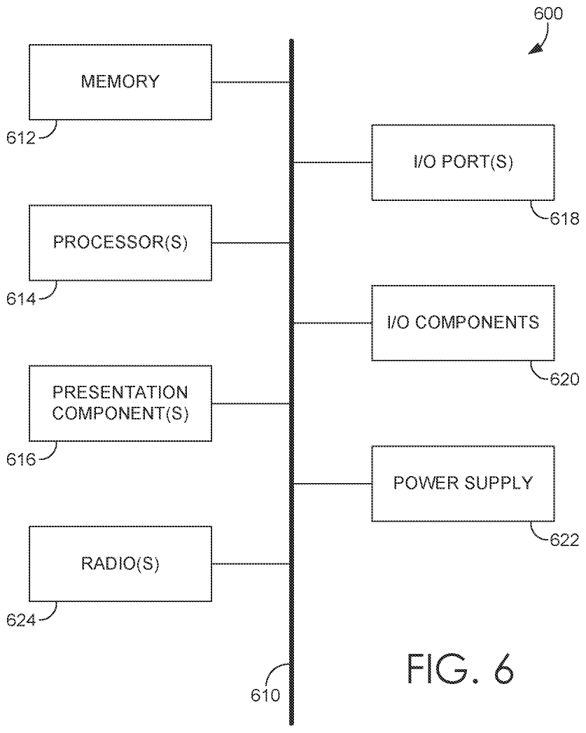

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service. The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby base station. A UE may be, in an embodiment, similar to device 600 described herein with respect to FIG. 6.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point.

In aspects, a UE provides UE data including location and channel quality information to the wireless communication network via the access point. Location information may be based on a current or last known position utilizing GPS or other satellite location services, terrestrial triangulation, an access point's physical location, or any other means of obtaining coarse or fine location information. Channel quality information may indicate a realized uplink and/or downlink transmission data rate, observed signal-to-interference-plus-noise ratio (SINR) and/or signal strength at the user device, or throughput of the connection. Channel quality information may be provided via, for example, an uplink pilot time slot, downlink pilot time slot, sounding reference signal, channel quality indicator (CQI), rank indicator, precoding matrix indicator, or some combination thereof. Channel quality information may be determined to be satisfactory or unsatisfactory, for example, based on exceeding or being less than a threshold. Location and channel quality information may take into account the user device capability, such as the number of antennas and the type of receiver used for detection. Processing of location and channel quality information may be done locally, at the access point or at the individual antenna array of the access point. In other aspects, the processing of said information may be done remotely.

A service state of the UEs may include, for example, an in-service state when a UE is in-network (i.e., using services of a primary provider to which the UE is subscribed to, otherwise referred to as a home network carrier), or when the UE is roaming (i.e., using services of a secondary provider providing coverage to the particular geographic location of the UE that has agreements in place with the primary provider of the UE). The service state of the UE may also include, for example, an emergency only state when the UE is out-of-network and there are no agreements in place between the primary provider of the UE and the secondary provider providing coverage to the current geographic location of the UE. Finally, the service state of the UE may also include, for example, an out of service state when there are no service providers at the particular geographic location of the UE.

The UE data may be collected at predetermined time intervals measured in milliseconds, seconds, minutes, hours, or days. Alternatively, the UE data may be collected continuously. The UE data may be stored at a storage device of the UE, and may be retrievable by the UE's primary provider as needed and/or the UE data may be stored in a cloud based storage database and may be retrievable by the UE's primary provider as needed. When the UE data is stored in the cloud based storage database, the data may be stored in association with a data identifier mapping the UE data back to the UE, or alternatively, the UE data may be collected without an identifier for anonymity.

In accordance with a first aspect of the present disclosure a method for dynamic carrier aggregation is provided. The method begins with determining a channel condition for each channel of a plurality of channels that are being used for communication between a cell and a user equipment (UE). The method then continues with determining a utilization of each of the plurality of channels. Based on the determination that the channel condition exceeds a first threshold and the utilization exceeds a second threshold, one or more carrier aggregation modifications are performed. The carrier aggregation modifications can include increasing a number of channels assigned to the UE or decreasing a number of channels assigned to the UE.

A second aspect of the present disclosure provides a system for dynamic carrier aggregation. The system includes a cell in communication with a UE, with the UE incorporating one or more processors. The processors in the UE are configured to perform the steps of determining a first signal quality measurement of a first downlink signal between the cell and a UE. The processors are also configured to determine a set of channels that have been allocated to the UE. Based on the first signal quality measurement and the loading metric for each of the channels allocated to the UE, the processors can also perform one or more carrier aggregation modifications to the set of channels allocated to the UE.

Another aspect of the present disclosure is directed to a computer-implemented method for dynamic carrier aggregation. The method comprises determining a channel condition for each channel in a plurality of channels that are being used to communicate between a cell and the UE. A utilization of each of the plurality of channels is also determined. The computer-implemented method concludes with performing one or more carrier aggregation modifications based on at least one of the channel condition and the utilization of each of the plurality of channels.

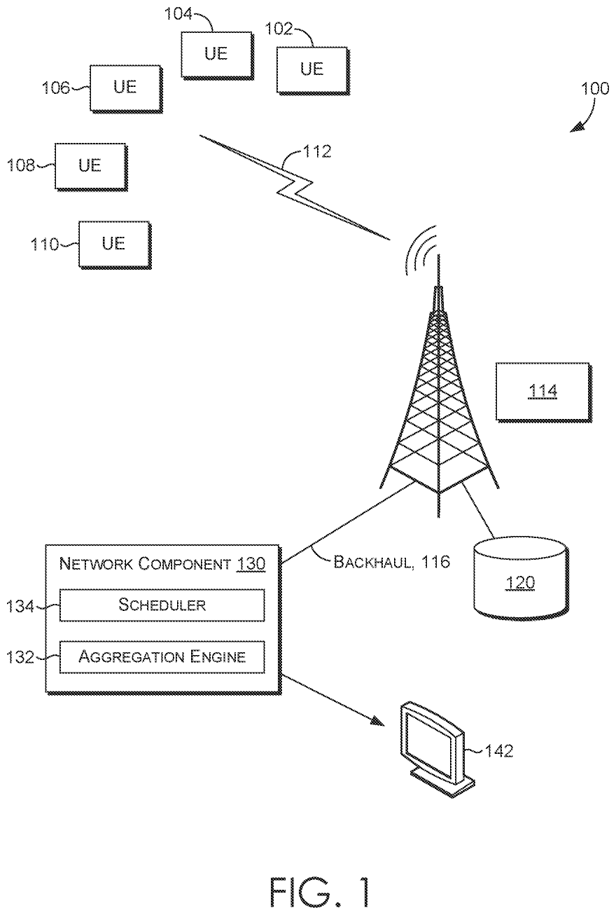

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement

Network environment 100 includes user devices (UE) 102, 104, 106, 108, and 110, access point 114 (which may be a cell site, base station, or the like), and one or more communication channels 112. The communications channels 112 can communicate over frequency bands assigned to the carrier. In network environment 100, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 400) that communicates via wireless communications with the access point 114 in order to interact with a public or private network.

In some aspects, each of the UEs 102, 104, 106, 108, and 110 may correspond to computing device 100 in FIG. 1. Thus, a UE can include, for example, a display(s), a power source(s) (e.g., a battery), a data store(s), a speaker(s), memory, a buffer(s), a radio(s) and the like. In some implementations, for example, a UEs 102, 104, 106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, CDMA, or any other type of network.

In some cases, UEs 102, 104, 106, 108, and 110 in network environment 100 can optionally utilize one or more communication channels 112 to communicate with other computing devices (e.g., a mobile device(s), a server(s), a personal computer(s), etc.) through access point 114. For example, a carrier can have two frequency bands FR1 and FR2. FR1 can cover 4.1 GHz to 7.125 GHz and FR2 can cover 24.25 GHz to 52.6 GHz. A carrier, or mobile network operator, may consider carrier aggregation (CA), which allows use of multiple sub-6 GHz spectrum channels simultaneously. CA groups several frequency bands to provide higher peak rates and increased cell coverage. In addition, CA extends coverage and increases network capacity. To further increase network performance frequency division duplex (FDD) and/or time division duplex (TDD) carrier aggregation can be implemented.

FDD and TDD are two different spectrum usage techniques. While FDD uses separate frequencies for uplink and downlink communication, TDD uses a single frequency for both uplink and downlink, with devices transmitting a different times. TDD can be more suitable when paired spectrum resources are not available. In general, FDD can provide better coverage, while TDD can provide better capacity.

The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, and the like) to user devices, such as UEs 102, 104, 106, 108, and 110. For example, the one or more communication channels may provide voice, SMS, and/or data services to UEs 102, 104, 106, 108, and 110, or corresponding users that are registered or subscribed to utilize the services provided by the telecommunications service provider. The one or more communication channels 112 can comprise, for example, a 1× circuit voice, a 3G network (e.g., CDMA, CDMA2000, WCDMA, GSM, UMTS), a 4G network (WiMAX, LTE, HSDPA), or a 5G network.

In some implementations, access point 114 is configured to communicate with a UE, such as UEs 102, 104, 106, 108, and 110, that are located within the geographic area, or cell, covered by radio antennas of access point 114. Access point 114 may include one or more base stations, base transmitter stations, radios, antennas, antenna arrays, power amplifiers, transmitters/receivers, digital signal processors, control electronics, GPS equipment, and the like. In particular, access point 114 may selectively communicate with the user devices using dynamic beamforming.

As shown, access point 114 is in communication with a network component 130 and at least a network database 120 via a backhaul channel 116. As the UEs 102, 104, 106, 108, and 110 collect individual status data, the status data can be automatically communicated by each of the UEs 102, 104, 106, 108, and 110 to the access point 114. Access point 114 may store the data communicated by the UEs 102, 104, 106, 108, and 110 at a network database 120. Alternatively, the access point 114 may automatically retrieve the status data from the UEs 102, 104, 106, 108, and 110, and similarly store the data in the network database 120. The data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the status data stored in the network database 120 current. For example, the data may be received at or retrieved by the access point 114 every 10 minutes and the data stored at the network database 120 may be kept current for days, which means that status data that is older than 30 days would be replaced by newer status data at 10 minute intervals. As described above, the status data collected by the UEs 102, 104, 106, 108, and 110 can include, for example, service state status, the respective UE's current geographic location, a current time, a strength of the wireless signal, available networks, and the like.

The network component 130 comprises an aggregation engine 132 and a scheduler 134. All determinations, calculations, and data further generated by the aggregation engine 132 and the scheduler 134 may be stored at the data store 140. Although the network component 130 is shown as a single component comprising the aggregation engine 132 and the scheduler 134 and the data store 140, it is also contemplated that each of the aggregation engine 132 and scheduler 134 may reside at different locations, be its own separate entity, and the like, within the home network carrier system.

The network component 130 is configured to retrieve signal quality metrics and carrier loading metrics from the base station or access point 114 or one of the UEs, 102, 104, 106, 108, and 110. Signal quality metrics can include any one or more of multiple metric, such as SINR, or may be RSRP. The aggregation engine 132 and the scheduler 134 work in conjunction to determine the locations of the UEs 102, 104, 106, 108, and 110 both within the network and within a particular cell site. The base station or access point 114 and the aggregation engine 132 and scheduler 134 determine the need for enabling or disabling Primary cells (Pcells) or Secondary cells (Scells) in the dual connectivity 5G network, such as the network 100. The aggregation engine 132 works in conjunction with scheduler 134 to disable one cell and allow selection between other cells. Enabling/disabling and cell selection can be based on loading on the particular carrier, SINR, RSRP, or other metrics.

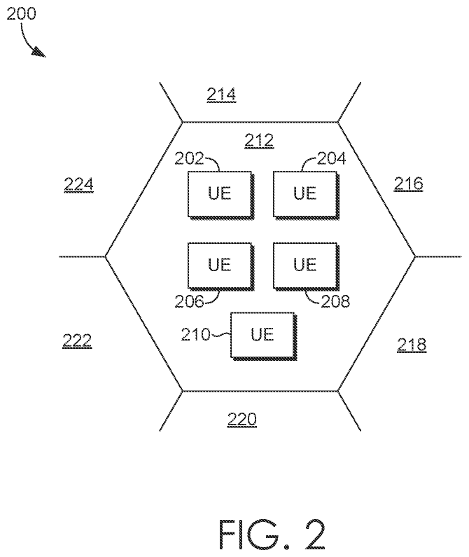

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cell sites 212, 214, 216, 218, 220, 222, 224, each including base station or access point 114, backhaul channel 116, antenna for sending and receiving signals over communication channels 112, network database 120 and network component 130. The size of the geographic area 200 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and 210, may be located within geographic area 200 collecting UE data that is useable by network component 130, in accordance with aspects herein. UEs 202, 204, 206, 208, and 210 can move within the cell currently occupying, such as cell 212 and can move to other cells such as adjoining cells 214, 216, 218, 220, 222 and 224.

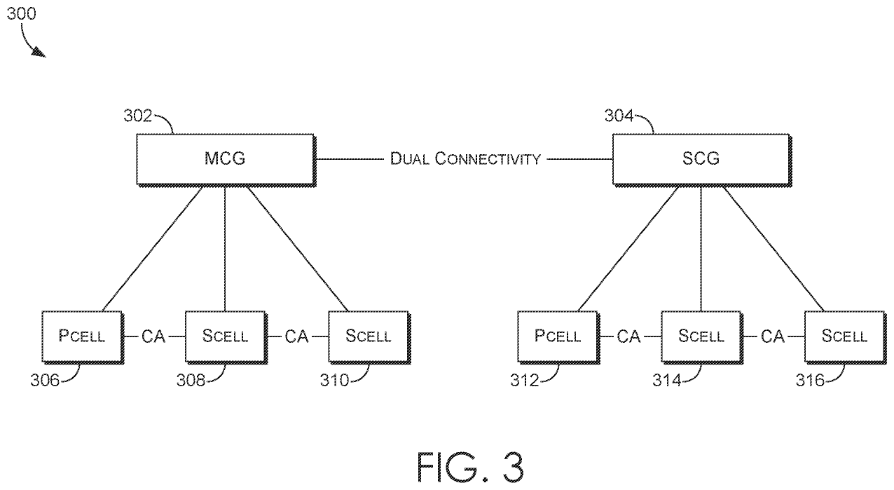

FIG. 3 depicts a dual connectivity network environment suitable for use in implementations of the present disclosure, in accordance with aspects herein. The cell sites discussed above in FIG. 2 may be dual connectivity cells in a 5G or 6G network. A dual connectivity cell 300 can include a master cell group (MCG) 302 and at least one secondary cell group (SCG) 304. The MCG 302 is connected to SCG 304 through dual connectivity. The MCG 302 can be located in a group in which a cell with which a UE, such as UEs 202, 204, 206, 208, and 210 in FIG. 2, first initiates random access.

There can be many cells under the MCG 302. A cell that is used to initiate initial access to the cell can be known as a Primary Cell (Pcell). The Pcell can be combined with a Secondary Cell (Scell) using carrier aggregation. The MCG 302 may be connected to a Pcell 306 and also, through carrier aggregation to Scell 308. Scell 308 is also in communication with MCG 308 and through carrier aggregation, Scell 310. Scell 310 is also in communication with MCG 302.

Similarly, the Secondary Cell Group (SCG) 304 is in communication with Pcell 312. Pcell 312 is in communication with Scell 314 through carrier aggregation. Scell 314 is also in communication with SCG 304. Scell 316 is in communication with Scell 314 using carrier aggregation and is also in communication with SCG 304.

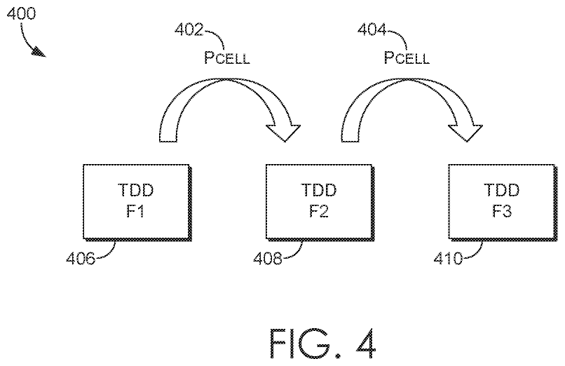

FIG. 4 depicts carrier aggregation between Primary Cells (Pcells) using different time division duplex (TDD) carriers, in which implementations of the present disclosure may be employed, in accordance with aspects herein. Some network systems use a 3 TDD carrier aggregation system or a FDD and TDD 5 carrier aggregation system. Both of these systems can benefit from dynamically prioritizing carriers and enabling or disabling Pcell or Scells based on loading and RF condition. Current carrier aggregation systems statically assigned and do not take loading and RF conditions into account. The carrier aggregation engine 132 working in conjunction with the scheduler 134 allows disabling of a New Radio (NR) 1700 Scell and selecting between a NR 1700, NR 1900 or NR 2500 for a Pcell based on loading. A NR 600 can be used as the Pcell at the cell edge.

The cell 400 in FIG. 4 can include TDD F1 406 can be the NR 1700 that is disabled and a selection is made to transfer to a TDD F2 408 as the Pcell 402 handling current calls and data exchanges. Later, TDD F2 operating on Pcell 402 can be transferred to Pcell 404 utilizing TDD F3 410. TDD F3 could be the NR 600 and Pcell 404 could be at the cell edge.

Dynamic carrier aggregation can also be used in conjunction with 3 TDD inter-band carrier aggregation. In this situation, the UE, such as the UEs 202, 204, 206, 208, and 210 of FIG. 2, can select the least loaded carrier on which to send uplink information. In some cases, this can be used to eliminate the third carrier, when loading conditions permit. The carrier count can also be downgraded based on load and traffic conditions measured on the carriers.

Loading of the carriers can be determined based on the utilization rate of physical resource blocks (PRBs). A PRB consists of twelve consecutive subcarriers for one slot of 0.5 ms. A PRB is the smallest element of resource allocation assigned by the scheduler 134 of FIG. 1.

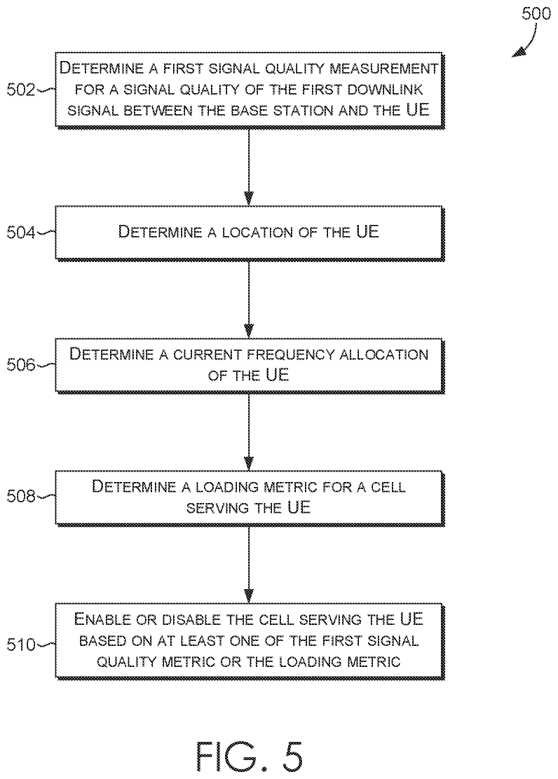

FIG. 5 is a flow chart of an exemplary method for improving 5G/6G carrier aggregation, in which aspects of the present disclosure may be employed, in accordance with aspects herein. The method 500 begins with step 502, determine a first signal quality measurement for a signal quality of the first downlink signal between the base station and the UE. The UE can be any one of the UEs 102, 104, 106, 108, and 110 of FIG. 1. The signal quality measurement may be a signal-to-noise and interference (SINR) measurement or may be a reference signal received power (RSRP) measurement. Other measurements of signal quality can also be used. Next, in step 504 the method continues with determine a location of the UE. The cell can be any one of the cells in FIGS. 2, 212, 214, 216, 218, 220, 222, and 224. Determining a location of the UE can also include determining whether the UE is currently served by a Pcell or a Scell. The Pcell can be any of the Pcells 306, or 312 in FIG. 3. Then, in step 506 the method continues with determine a current frequency allocation of the UE. The method then provides for determine a loading metric for a cell serving the UE in step 508. The loading metric may be based on the number of physical resource blocks (PRBs) used in either the downlink or uplink signals sent or received by the UE. After the first signal quality measurement, UE location, current frequency of the UE, and loading metric of the cell serving the UE have been determined, the method continues with step 510 enable or disable the cell serving the UE based on at least one of the first signal quality metric or the loading metric. The determination to enable or disable the cell serving the UE can be based on the network conditions falling below a pre-determined threshold for RSRP or SINR. If this occurs, the carrier aggregation-based allocations can be downgraded. Carrier loading can also be determined by determining the number of UEs assigned to the carrier in question, in which case the least loaded carrier could be disabled. Enabling or disabling Pcells or Scells is performed by the scheduler 134 of FIG. 1. The scheduler 134 can assign a weight to each carrier and determine a cost function that correlates to network performance when using the carrier in question.

FIG. 6 depicts an exemplary computing device suitable for use in implementations of the present disclosure, in accordance with aspects herein. With continued reference to FIG. 6, computing device 600 includes bus 602 that directly or indirectly couples the following devices: memory 604, one or more processors 606, one or more presentation components 608, input/output (I/O) ports 612, I/O components 610, radio 616, transmitter 618, and power supply 614. Bus 602 represents what may be one or more busses (such as an address bus, data bus, or combination thereof). Although the devices of FIG. 6 are shown with lines for the sake of clarity, in reality, delineating various components is not so clear, and metaphorically, the lines would more accurately be grey and fuzzy. For example, one may consider a presentation component such as a display device to be one of I/O components 610. Also, processors, such as one or more processors 606, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 604 includes computer-storage media in the form of volatile and/or nonvolatile memory. Memory 604 may be removable, nonremovable, or a combination thereof. Exemplary memory includes solid-state memory, hard drives, optical-disc drives, etc. Computing device 600 includes one or more processors 606 that read data from various entities such as bus 602, memory 604 or I/O components 610. One or more presentation components 608 present data indications to a person or other device. Exemplary one or more presentation components 408 include a display device, speaker, printing component, vibrating component, etc. I/O ports 612 allow computing device 600 to be logically coupled to other devices including I/O components 610, some of which may be built into computing device 600. Illustrative I/O components 610 include a microphone, joystick, game pad, satellite dish, scanner, printer, wireless device, etc.

The radio 616 represents one or more radios that facilitate communication with a wireless telecommunications network. While a single radio 616 is shown in FIG. 6, it is contemplated that there may be more than one radio 616 coupled to the bus 602. In aspects, the radio 616 utilizes a transmitter 618 to communicate with the wireless telecommunications network. It is expressly conceived that a computing device with more than one radio 616 could facilitate communication with the wireless telecommunications network via both the first transmitter 618 and an additional transmitters (e.g. a second transmitter). Illustrative wireless telecommunications technologies include CDMA, GPRS, TDMA, GSM, and the like. The radio 616 may additionally or alternatively facilitate other types of wireless communications including Wi-Fi, WiMAX, LTE, 3G, 4G, LTE, 5G, NR, VoLTE, or other VoIP communications. As can be appreciated, in various embodiments, radio 616 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for dynamic carrier aggregation, comprising:
determining a channel condition for each channel of a plurality of channels being used to communicate between a cell and a user equipment (UE);
determining a utilization of each of the plurality of channels; and
based on a determination that the channel condition exceeds a first threshold and the utilization exceeds a second threshold, performing one or more carrier aggregation modifications.

2. The method of claim 1, wherein the one or more carrier aggregation modifications comprises assigning the UE an additional channel.

3. The method of claim 1, wherein the cell is a primary cell (Pcell).

4. The method of claim 1, wherein the cell is a secondary cell (Scell).

5. The method of claim 1, further comprising determining that utilization of a second channel of the plurality of channels is less than utilization of a first channel.

6. The method of claim 1, wherein the one or more carrier aggregation modifications comprise downgrading a number of channels assigned to the UE.

7. The method of claim 1, wherein determining a channel condition is based on a signal-to-interference and noise (SINR) ratio.

8. The method of claim 1, wherein determining the utilization of the plurality of channels is based on an amount of physical resource blocks assigned (PRBs).

9. The method of claim 1, wherein determining a channel condition is based on a reference signal received power (RSRP) measurement.

10. The method of claim 6, wherein downgrading a number of channels assigned to a user equipment is based on at least one of the utilization and the channel condition measuring below a predetermined threshold.

11. A system for dynamic carrier aggregation, comprising:
a cell in communication with a user equipment (UE), the UE incorporating one or more processors configured to perform a method comprising:
determining a first signal quality measurement of a first downlink signal between the cell and the UE;
determining a set of channels allocated to the UE;
determining a loading metric for each of the channels allocated to the UE; and
performing one or more carrier aggregation modifications to the set of channels allocated to the UE based on the first signal quality measurement.

12. The system of claim 11, wherein performing one or more carrier aggregation modifications includes consolidating from a first set of channels to a second set of channels, wherein the second set of channels has fewer channels than the first set of channels.

13. The system of claim 11, wherein the first signal quality metric is a signal-to-interference and noise (SINR) ratio.

14. The system of claim 11, wherein the first signal quality metric is a reference signal received power (RSRP) measurement.

15. The system of claim 11, wherein the loading metric is based on a utilization rate of physical resource blocks (PRBs).

16. The system of claim 11, wherein the loading metric is based on a weight assigned to each group of channels.

17. A computer-implemented method for dynamic carrier aggregation, comprising:
determining a channel condition for each channel in a plurality of channels being used to communicate between a cell and a user equipment (UE);
determining a utilization of each of the plurality of channels; and
performing one or more carrier aggregation modifications based on at least one of the channel condition and the utilization of each of the plurality of channels.

18. The computer-implemented method of claim 17, wherein the cell uses time division duplexing (TDD) and at least three different frequencies.

19. The computer-implemented method of claim 17, wherein the utilization of each of the plurality of channels is based on a utilization rate of physical resource blocks (PRBs).

20. The computer-implemented method of claim 17, wherein performing one or more carrier aggregation modifications is based on at least one of the channel condition or the utilization of each of the plurality of channels falling below a predetermined threshold.
